(19) United States
(12) Patent Application Publication
(10) Pub. No.: US 2006/0017233 A1
(43) Pub. Date: Jan. 26, 2006

(54) Flange design conception: flanges of inverse flexion

(76) Inventor: Anatoly Efremov, Albuquerque, NM (US)

Correspondence Address: ANATOLY EFREMOV, 9923 Osuna Rd. NE, Albuquerque, NM, 87111, US

(21) Appl. No.: 10/972,891

(22) Filed: Oct. 26, 2004

Related U.S. Application Data
(60) Provisional application No. 60/516,784, filed on Nov. 3, 2003.

(51) Int. Cl. H02G 15/013

(52) U.S. Cl. 277/602

(57) ABSTRACT

A flange design conception is disclosed. The conception relates to the flanges for making leak-tight flanged connections between component parts of pressure vessels, piping systems, boilers, reactors, heat exchangers, and the like. By providing inverse flexion of the flanges during the fastener preload the invention increases the leak tightness of the flanged connections under conditions of high internal operating pressure.

### CROSS-REFERENCE TO RELATED APPLICATIONS

This invention claims the benefit of an earlier filed co-pending U.S. Provisional Patent Application Ser. No. 60/516784, filed Nov. 03, 2003, the disclosure of which is hereby incorporated herein by reference.

### FEDERALLY SPONSORED RESEARCH

Not Applicable

### SEQUENCE LISTING OR PROGRAM

Not Applicable

### BACKGROUND OF THE INVENTION

1. Field of the Invention

A present invention relates to leak-tight flanged connections between component parts of critical process facilities such as pressure vessels, piping systems, boilers, reactors, and the like.

2. Background of the Invention

One of the most actually used ways to obtain a leak-tight joint between component parts of different industrial facilities is to connect their pieces with flanges which are fastened together to create a necessary tight joint. These flanged connections have a wide applicability in petrochemical, chemical, aerospace, fossil fuel and nuclear power industries, and others.

A typically used flanged connections have a raised-face or flat-face standardized flange design, and separate sealing elements, such as gaskets, are usually placed and compressed between adjacent flange faces to ensure a suitable leak tightness of the flanged connections. A typically used flange fasteners are the bolts with nuts that have to provide a necessary clamping forces while preloading and following operating internal pressure. However, such flange design cannot guaranty sufficient operating leak tightness, particularly when component parts with flanges are subjected to operating high internal pressure and elevated temperatures.

Industry experience with continuing flanged joint leakage has demonstrated that leakage events lead to bolt damages and failures that are attributed to high rate of corrosion that is combined with high level of stresses and deformations due to alternating conditions of internal pressure, elevated temperatures, flow-induced vibrations, and other critical factors. In fact, the typically used bolted flanged connections of critical process industries experience an increase of the number of reported bolt damages and failures. Basic bolting applications where damages or failures have been detected include the bolted flanged connections of pressure vessels, piping systems, component supports, and others, and the main cause of bolt damages and failures is an early leakage due to low leak tightness of typically used bolted flanged connections.

While the bolted flanged connections appear to be a very simple device, it is highly complex for analysis from leakage event point of view, particularly when creep and relaxation, elevated temperatures, integral flow of neutrons, and other critical factors take place. Some experimental and analytical investigations allowed to find an effect of flange flexion and rotation leading to decrease of the bolt preload and early joint opening while increasing of internal operating pressure. The early joint opening occurs with simultaneous early leakage that indicates a decrease of clamping forces and gasket compression, and it is exactly the early leakage that leads directly to the bolt corrosion, degradation and failure, and that reduces the service life of critical process facilities.

A wide range of patent documents is dedicated to flange design improvements to reduce a plant process leakages and to increase a leak tightness of bolted flanged connections. Most of these patents relate to the gasketed joints to disclose a sophisticated gasket shapes, and some patents are directly connected with flange design to change the flange interaction with gaskets or other sealing elements during the fastener preload followed by internal operating pressure.

One of the first flanges described in DE Pat. No. 64013 to Schwoerer has a small clearance between adjacent flange faces located at the periphery of the flanges and bridged by the bolt preload to ensure a clamping of lens-shape gasket. Same approach is used in DE Pat. No. 124 715 to Janke, and in GB Pat. No. 2200179 to Porter.

DE Pat. No. 124715 discloses superimposed annular flanges having a small clearance at the periphery of flanges that is bridged by the bolt preload to clamp a gasket that is compressed between two tube ends.

GB Pat. No. 2200179 describes a flanged joint having a small clearance at the periphery of flanges that is closed when the bolts are correctly tightened forming an initial joint between inner flat faces of the flanges by means of metal-to-metal contact.

All these patent documents reproduce on the whole a conventional approach to the flange design based on application of raised-face or flat-face flanges. The main difference that is disclosed in GB Pat. No. 2200179 consists in flange resistance to overstressing of the bolts during tightening, and to axial tension and external bending.

Next attempts to improve a flange design in relation of leak tightness increase are contained in U.S. Pat. No. 2412487 to Amley, FR Pat. No. 1024183 to Syndicat Dauphinois, GB Pat. No. 1210291 to Haworth, U.S. Pat. Nos. 3135 538 to George, 3771817 to Schnabel, and DE Pat. No. 2430627 to Prodan at al.

All these patents disclose the means to change a shape of adjacent flange faces to increase a compression of the gaskets or other sealing elements. The common approach used in cited patent documents consists in fabrication of frusto-conical faces of adjacent flanges having a hollow space to place a gasket or other sealing elements that are compressed during the bolt preload.

GB Pat. No. 1210291 entitled “Metal to Metal Joint” discloses a sealing joint between two members which comprise metals of different elastic limits, the member having the lower elastic limit is adapted to form area contact by means of plastic deformation of its initial frusto-conical shape during the bolt tightening.

U.S. Pat. No. 3771817 describes a similar approach to join two mutually braced metal parts of the pipes having a covering of plastic material. The metal parts have annular clamping flanges of frusto-conical shape with hollow space adapted to extend parts of plastic material. The flanges have a free peripheral edge for compressing the plastic material between annular clamping faces in hollow space, so that the plastic material may flow into the hollow space to provide a perfect seal during the bolt tightening.

The similar approach is described in U.S. Pat. Nos. 2412487 and 3135538.

DE pat. No. 2430627 to Prodan at al. describes a method to seal the raised-face flanges by means of their deformation during the bolt preload that provides a tight and continuous contact between adjacent flange faces and gasket. This method is important one but it is applied to conventional raised-face flanges so that its significance reduces substantially.

FR Pat. No. 1024183 proposes a sealing joint with flanges of sophisticated shape having frusto-conical parts and internal annular cavities that facilitates a flange deformations during the bolt preload to provide a contact stress distribution favorable for leak tightness improvement.

A common weakness of all cited above prior patent documents is a general approach to form a flange design by means of raised-face flanges that creates condition favorable for early joint opening. Moreover, the mechanism leading to early leakage has been remained out of limits of these inventions. None of the above-mentioned prior approaches have contemplated the formation of an effective approach to the flange design such as envisioned by the present invention. Accordingly, it is main object of the present invention to form a new flange design conception and to provide high leak tightness of bolted flanged connections compared with typically used ones.

### SUMMARY OF THE INVENTION

The present invention discloses the flange design conception to increase the leak tightness of bolted flanged connections subjected to internal operating pressure. This conception is alternative to typically used one because it is based on qualitative change the sealing mechanism to fasten the flanges by means of bolt tightening and rigid contact between adjacent flange faces on their outer part. The remainder of adjacent flange faces forms an internal hollow space adapted for placing a sealing element such as compliant gasket or so on.

A most important advantage of the present invention is a better sealing against leakage because the fastener preload leads to initial flange flexion and rotation around outer rigid contact surface at the direction inverse to the direction of flexion and rotation of typically used raised-face flanges. The compliant gasket or other sealing element forms a second contact surface, and internal operating pressure corresponding to early joint opening must by significantly increased to overcome inverse flexion of the flanges and resistance of rigidly fixed flange fasteners.

A realization of described flange design conception consists in practical application of flanges of inverse flexion to connect component parts of pressure vessels, boilers, reactors, piping systems, and the like. One of the versions of the present invention may be obtained with use of accompanying drawings, which illustrate the present flange design conception, and along with detailed description help to explain the principles of the present invention.

### BRIEF DESCRIPTION OF THE DRAWINGS

FIG. 1a is a part of the cross section of a pressure vessel that illustrates weaknesses of raised-face type of bolted flanged connection in order to explain the advantages of the present invention.

FIF. 1b is a schematic representation of flange flexion of circular cover of the pressure vessel shown in FIG. 1a subjected to the bolt preload.

FIG. 2a is a same type of raised-face flanges as shown in FIG. 1a except that the assembly is subjected to internal operating pressure.

FIG. 2b is a schematic representation of flange flexion of circular cover of the pressure vessel shown in FIG. 2a due to internal operating pressure.

FIG. 3a shows a part of the cross-section of the flanges of inverse flexion of a pressure vessel according to the present invention.

FIG. 3b is a schematic representation of flange flexion of circular cover of the pressure vessel shown in FIG. 3a subjected to the bolt preload.

FIG. 4a is a same type of the flanges of inverse flexion as shown in FIG. 3a except that the assembly is subjected to internal operating pressure.

FIG. 4b is a schematic representation of flange flexion of circular cover of the pressure vessel shown in FIG. 4a due to internal operating pressure.

### DETAILED DESCRIPTION OF THE INVENTION

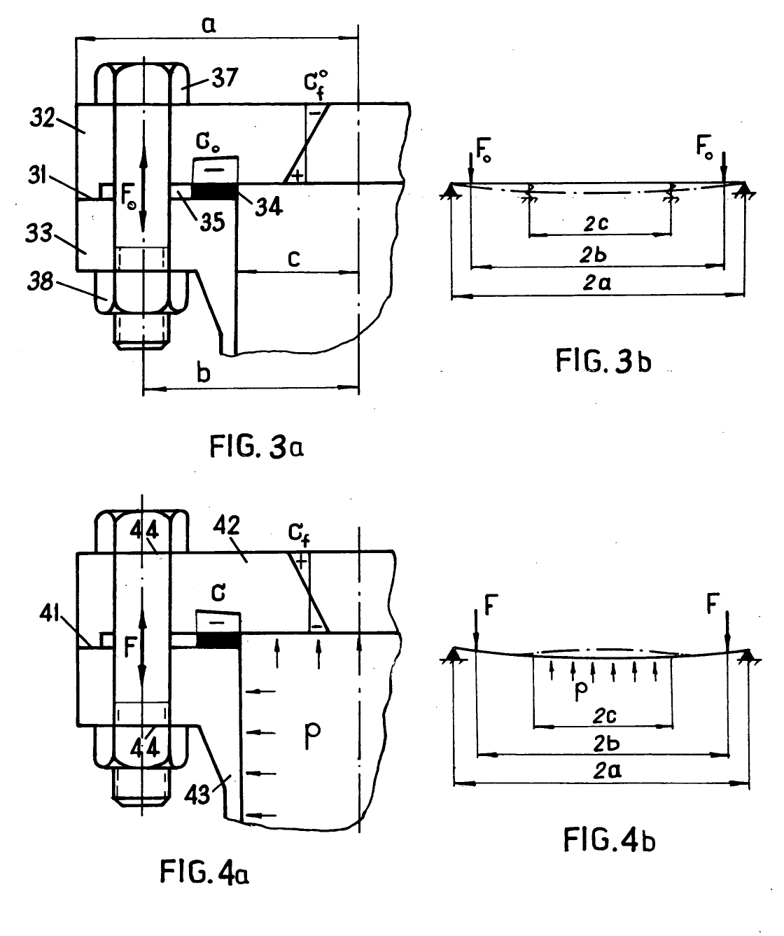

FIG. 3a is preferred embodiment

FIG. 1a shows one of typically used and standardized types of bolted flanged connection of a pressure vessel having annular joint between the cover 11 and base 12, each component part has a raised-face flange rings 13 (cover) and 14 (base) extending radially outwardly with a compliant gasket 15 between adjacent flange faces, the flange rings being connected by means of bolts 16 and nuts 17. The assembly is under conditions of bolt preload “F₀”. It is also shown a distribution of gasket compression stresses “σ₀”, and radial bending stresses “σ_{f}⁰” at the cover due to bolt preload “F₀” and flange flexion and rotation around bearing gasket contact surfaces.

The stress distributions correspond to analytical and experimental data obtained, for example, from investigation of circular plate shown in FIG. 1b and representing schematically circular cover 11 of pressure vessel subjected to the bolt preload as shown in FIG. 1a.

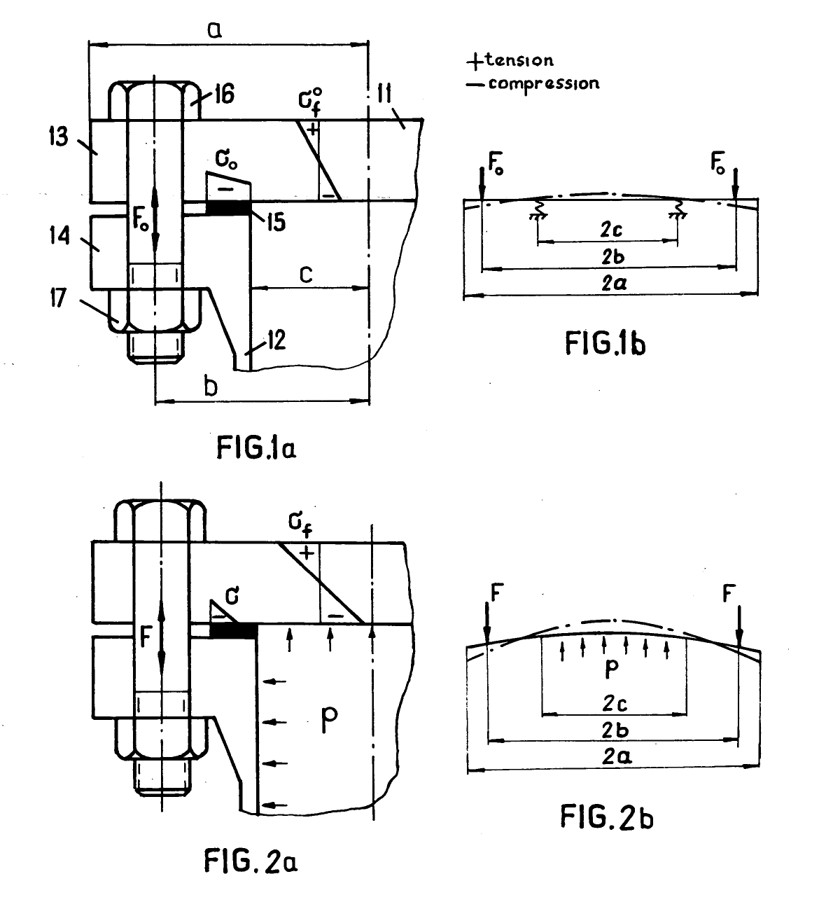

FIG. 2a is the same bolted flanged connection with raised-face flanges subjected to internal operating pressure “p”. The continuing flange flexion and rotation around bearing gasket contact surfaces changes the distribution of gasket compression stresses “σ” with simultaneous increase of radial bending stresses “σ_{f}” at the cover. The described mechanism of flange flexion and rotation leads to early joint opening and creates conditions favorable for early leakage because of decrease of gasket compression stresses and of direction of flange flexion obtained from bolt preload that coincides with direction of flange flexion due to internal operating pressure as shown schematically in FIG. 2b.

The leakage event is a very serious problem for plant process industries and others. For example, petrochemical engineers who must cope with rotation of the flanges testify that it can greatly increase the difficulties of sealing joints; some even affirm that rotation as small as 0.1 DEG can make a tight joint almost impossible.

FIG. 3a illustrates the present flange design conception based on application of flanges of inverse flexion having an annular rigid contact face 31 on outer part of flange rings 32, 33 and compliant gasket 34 that is placed between flange faces into hollow space 35, the flange bolts 37 with nuts 38 being placed between compliant gasket 34 and annular rigid contact face 31.

The annular rigid contact face 31 on outer part of flange rings is a bearing contact surface of the flanges that are subjected to the bolt preload “F₀”. The flange flexion and rotation around rigid contact face 31 have a direction shown in FIG. 3b that is a schematic representation of a circular plate subjected to the bolt preload “F₀”. The flange flexion and rotation have a direction inverse to the flange flexion and rotation of typically used bolted flanged connection with raised-face flanges as is shown in FIG. 1b. The gasket compression stresses “σ₀” distribution along with bending stresses “σ_{f}⁰” at the cover are shown in FIG. 3a. The bending stresses have a distribution inverse to the one that is shown in FIG. 1a, so that the upper layers of the cover are compressed, and the lower layers are stretched.

FIG. 4a shows the same type of bolted flanged connection of the cover 42 and base 43 with flanges of inverse flexion under conditions of internal operating pressure “p”. The flanges have the annular rigid contact support 41 and bolt contact supports 44 that are located on outer end of the flanges. FIG. 4b is a schematic representation of circular plate corresponding to the cover 42 subjected to internal operating pressure “p”. The flexion and rotation of the flanges are stopped by resistance of rigid supports and bolts on outer end of the flanges. The gasket stresses “σ” remain the stresses of compression along gasket contact surface, but bending stresses “σ_{f}” at the cover change the sights, so that the upper layers of the cover are stretched and lower layers are compressed that is shown in FIG. 4a. Analytical and experimental data show that joint opening occurs with significant increase of internal operating pressure “p” that is almost four times greater than internal operating pressure for similar conditions of the joint opening obtained for typically used raised-face flanges. The application of the flanges of inverse flexion results in significant increase of the leak tightness compared with typically used ones.

### CONCLUSION

The present flange design conception is based on a new effect of flange flexion and rotation around rigid contact face situated on outer part of the flanges. This effect results in significant increase of the leak tightness of critical process facilities of petrochemical, chemical, aerospace, fossil fuel and nuclear power industries, and others

The analytical and experimental investigations of bolted flanged connections with flanges of inverse flexion show that early leakage occurs with considerable increase of internal operating pressure compared with typically used raised-face flanges. The real application of the flanges of inverse flexion will allow to protect the fasteners and component parts of the bolted flanged connections from damages due to corrosion, to extend the service life of critical process facilities or to intensify technological processes with significant increase of internal operating pressure.

It is evident that various changes in the details, materials, arrangement of the fasteners and component parts of the flanges of inverse flexion which have been described and illustrated above may be made by those skilled in art without departing from the principles of the present flange design conception that are disclosed in applied claims.

What I claim as my invention is:

1. A flange design conception, said conception is based on a change of the direction of flange flexion and rotation compared with typically used raised-face flanges while subjecting to the fastener preload.

2. A flange design conception according to claim 1 wherein said direction of flange flexion and rotation during said fastener preload results from the flange flexion and rotation around rigid contact face situated on outer part of the flanges.

3. A realization of said flange design conception by means of flanges of inverse flexion having the fasteners such as bolts and nuts situated between rigid contact face on outer part of the flanges and compliant gasket or other sealing element on inner part of the flanges.

4. Said flanges of inverse flexion according to claim 3 having an internal hollow space between adjacent flange faces adapted for placing a gasket or other sealing element.
